(19) United States
(12) Patent Application Publication
(10) Pub. No.: US 2018/0354424 A1
(43) Pub. Date: Dec. 13, 2018

(54) LIGHTED SAFETY LADDER

(71) Applicant: MAC LTT, INC., Kent, OH (US)

(72) Inventor: James A. Maiorana, Hartville, OH (US)

(73) Assignee: MAC LTT, INC.

(21) Appl. No.: 15/620,309

(22) Filed: Jun. 12, 2017

(51) Int. Cl. B60R 3/00; E06C 7/00; E06C 7/16

(52) U.S. Cl. CPC B60R 3/007; E06C 7/16; E06C 7/003

(57) ABSTRACT

A lighted safety ladder includes two rails and a plurality of rib members connected to the two rails. A platform may be provided at one end of the ladder and is located above an uppermost one of the plurality of ribs. A light source is provided on one or both of the rails; one or more of the plurality of rib members; and one the platform. The light source may be in the form of a light emitting diode (LED) strip that is installed in a slot defined in the rails, the rib members or the platform or that is adhered or otherwise secured to the surface of the rail, rib member or platform. The light source provides illumination to the rails, rib members and/or platform so that an operator may better see these components in low lighting conditions.

### BACKGROUND

### Technical Field

The present disclosure relates generally to ladders. More particularly, the present disclosure relates to safety ladders. Specifically, the present disclosure is directed to a lighted safety ladder.

### Background Information

The use of ladders is commonplace in commercial and personal applications. Unfortunately, some commercial and personal tasks are performed where lighting conditions are not optimal for performing such tasks. Truckers, for example, may need to climb up and down ladders on their trucks during the night or at twilight. People cleaning commercial tanks may have to climb down into the tank to perform the cleaning operation. Operating a ladder in such low lighting conditions is dangerous as the operator may not be able to see exactly where to place their hands and feet as they climb up or down the ladder. This may lead to the operator falling off the ladder and potentially hurting themselves.

### SUMMARY

The inventor has recognized that the safety of operators utilizing ladders in low lighting conditions would be improved if some of the ladder components were made more visible. The ladder and method disclosed herein address some of the issues with previously known ladders.

A lighted safety ladder is disclosed herein that includes two rails and a plurality of rib members connected to the two rails. A platform may be provided at one end of the ladder and is located above an uppermost one of the plurality of ribs. A light source is provided on one or both of the rails; one or more of the plurality of rib members; and one the platform. The light source may be in the form of a light emitting diode (LED) strip that is installed in a slot defined in the rails, the rib members or the platform or that is adhered or otherwise secured to the surface of the rail, rib member or platform. The light source provides illumination to the rails, rib members and/or platform so that an operator may better see these components in low lighting conditions.

In one aspect, the present disclosure may provide a lighted safety ladder comprising two rails; a plurality of rib members connected to the two rails; and a light source provided on one of the two rails or one of the plurality of rib members

In another aspect, the present disclosure may provide, in combination, a vehicle including a trailer and a safety ladder mountable to the trailer. The safety ladder comprises two rails and a plurality of rib members connected to the two rails. The safety ladder further includes a light source provided on the safety ladder.

In another aspect, the present disclosure may provide a method for illuminating a safety ladder comprising providing a ladder including two rails and a plurality of rib members connected to the rails. The method includes mounting a light source to the ladder. The method includes emitting light from the light source. The method includes illuminating one of the rails or one of the plurality of rib members with light emitted from the light source.

### BRIEF DESCRIPTION OF THE SEVERAL VIEWS OF THE DRAWINGS

A sample embodiment of the disclosure is set forth in the following description, is shown in the drawings and is particularly and distinctly pointed out and set forth in the appended claims.

FIG. 1 is a front perspective view of a lighted safety ladder in accordance with an aspect of the present disclosure showing a light source provided on the rails;

FIG. 2 is a front perspective view of the ladder showing the light source provided on the plurality of rib members and the platform;

FIG. 3A is a cross section of a rail taken along line 3-3 of FIG. 1;

FIG. 3B is a side elevation view showing a second embodiment of the light source;

FIG. 4 is a perspective view of the LED strip utilized to light the rails, the rib members or platform of the ladder;

FIG. 5 is a right side elevation view of a conventional tanker truck incorporating two differently configured lighted safety ladders in accordance with an aspect of the present disclosure;

FIG. 6 is an enlarged view of the highlighted region of FIG. 5 showing the lighted safety ladder attached to the tanker truck;

FIG. 6A is an enlarged perspective view of the highlighted region of FIG. 5 showing the lighted safety ladder attached to the tanker truck;

FIG. 7 is a right side elevation view of a conventional dump truck incorporating two of the lighted safety ladders in accordance with an aspect of the present disclosure; and

FIG. 8 is a flowchart depicting an exemplary method for illuminating a safety ladder in accordance with an aspect of the present invention.

Similar numbers refer to similar parts throughout the drawings.

### DETAILED DESCRIPTION

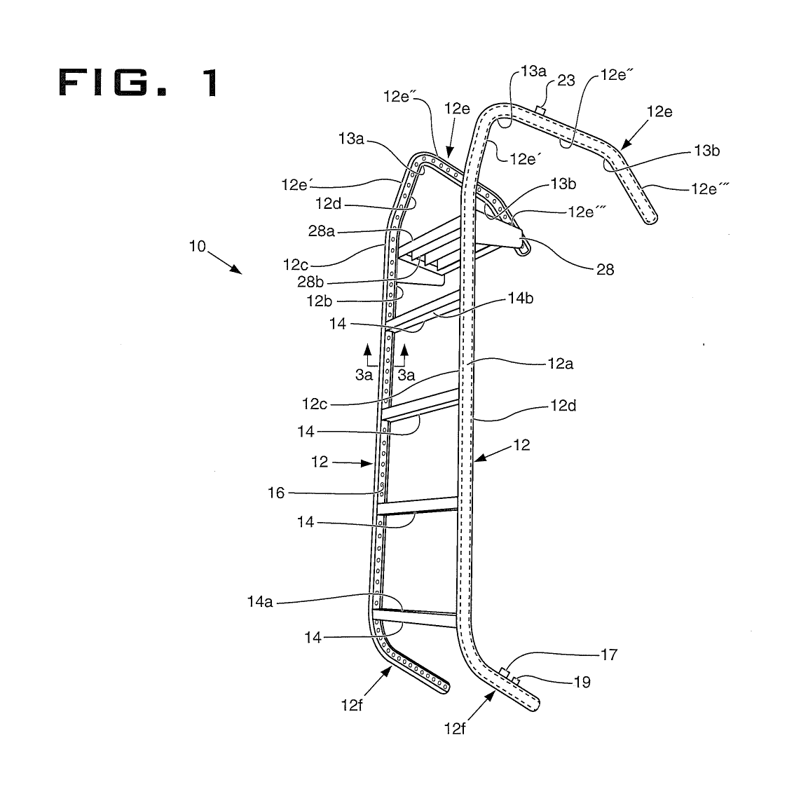

Referring to FIG. 1-FIG. 8 there is shown a lighted safety ladder in accordance with an aspect of the present disclosure, with the ladder generally indicated at 10. Ladder 10 includes a pair of rails 12, a plurality of rib members 14, and a light source 16.

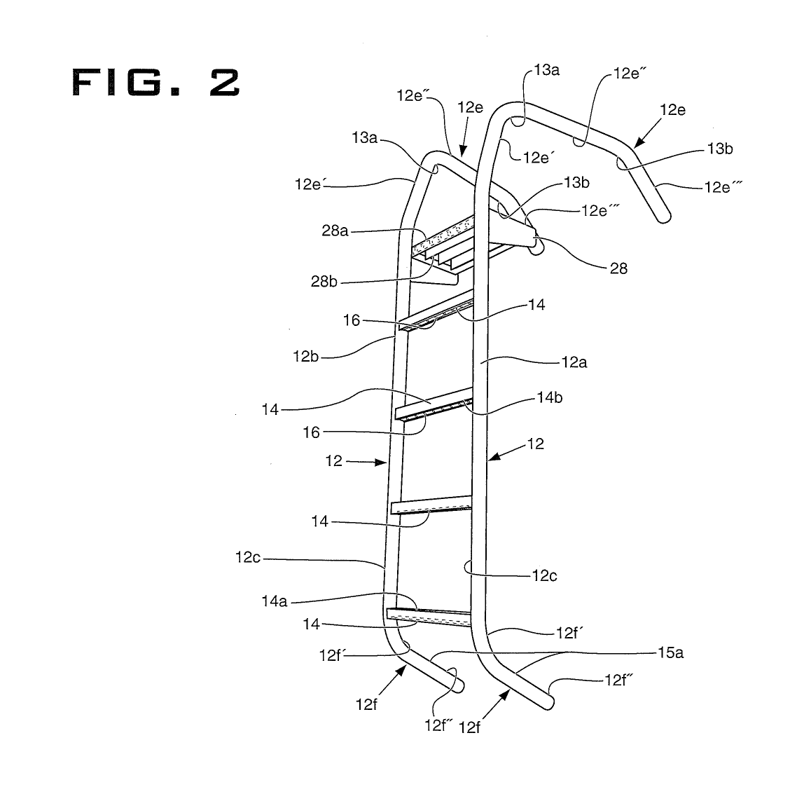

As shown in FIG. 1 and FIG. 2, rails 12 may be spaced apart and parallel to one another. Each rail 12 may be a generally cylindrical member having a generally circular cross-section. Each rail 12 may include an exterior side 12a, an interior side 12b, a first edge 12c, a second edge 12d, a first end 12e and a second end 12f. Each rail 12 may be formed from an extrudable material by an extrusion process. The extrudable material may be aluminum; however any other suitable extrudable material may be utilized to fabricate ladder 10.

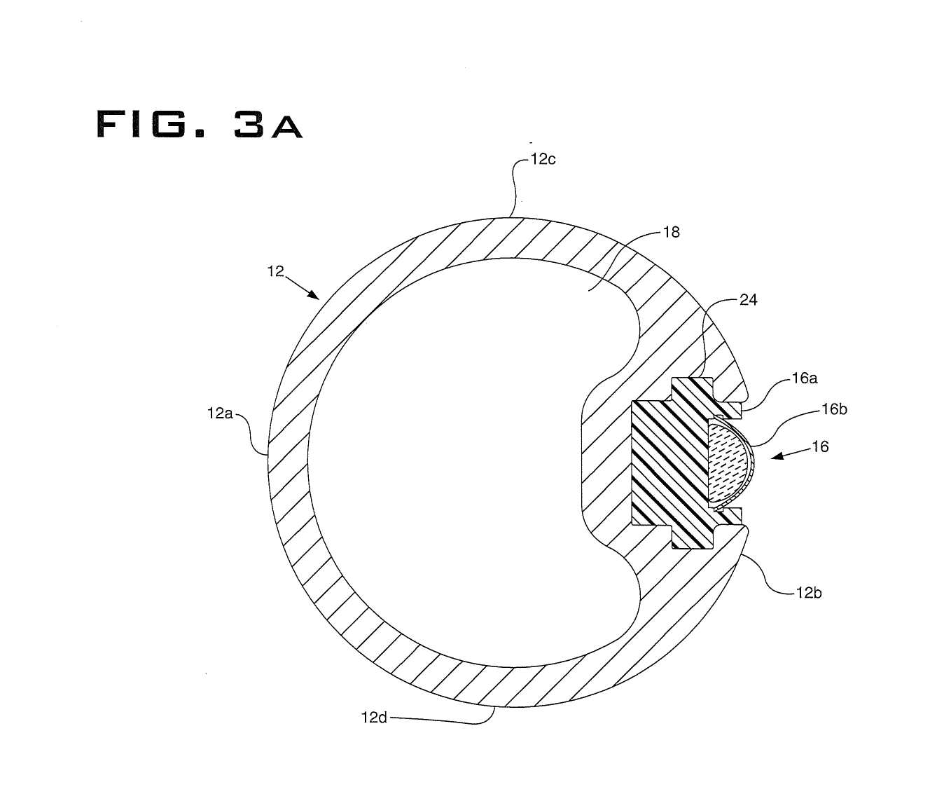

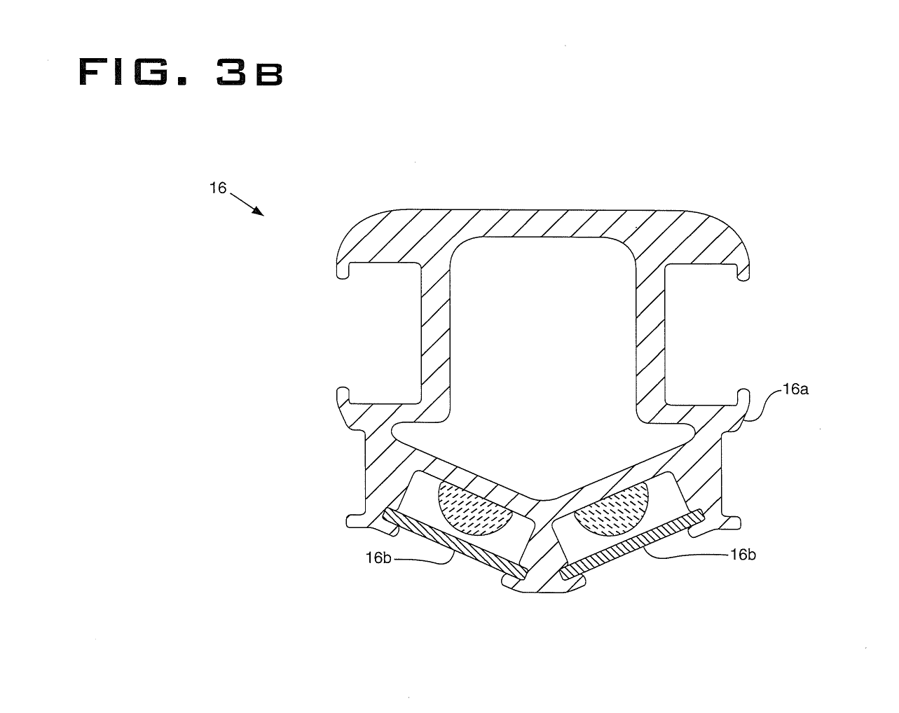

Each rail 12 may be substantially hollow and formed with an interior cavity 18 (FIG. 3A) extending a length of rail 12. Cavity 18 may be bounded and defined by exterior side 12a, interior side 12b, first edge 12c, second edge 12d, first end 12e and second end 12f. First end 12e and second end 12f may be adapted to be connected to a support member 20, such as a conventional tanker truck 22, in any suitable manner. Although support member 20 has been referenced herein as a tanker truck 22, support member 20 may be any suitable support member 20 including, but not limited to, other types of vehicles or stationary structures such as a side of a building, an upper lip of a tank, or a shelf of a warehouse.

Furthermore, although ladder 10 is shown and described herein as being of a configuration that is engaged with a support member 20, ladder 10 may, instead, be a free standing structure. In other words, ladder 10 may be of a configuration that may be placed with both ends on the ground to enable an operator to reach objects a distance above the ladder 10. It should therefore be understood that the ladder 10 itself may be of any shape.

As shown in FIG. 2, one end of ladder 10 may be shaped to form a handle section that may aid an operator in climbing onto and off of a top of support member 20. The first end 12e of each rail 12 may therefore include a first portion 12e′, a second portion 12e″ and a third portion 12e′″ that are connected end-to-end and are oriented at an angle to each other so that the first end 12e may be generally U-shaped. First portion 12e′ may be disposed at a first angle relative to a generally straight section of the rest of rail 12. The first angle may be approximately 10°; however, the first angle may be any suitable angle. Second portion 12e″ may be connected to first portion 12e′ by a first arcuate section 13a. Second portion 12e″ may be connected to third portion 12e′″ by a second arcuate section 13b. It will be understood that each entire rail 12 may be a single section of tubing that is bent into the illustrated shape or may comprise sections of tubing that are fixedly secured end-to-end by any suitable means such as welding. Although a particular configuration of first end 12e has been illustrated in FIG. 1 and described above, it will be understood that first end 12e may be of any suitable configuration.

As shown in FIG. 1 and FIG. 2, second end 12f may include a first portion 12f′ and a second portion 12f″. First portion 12f′ may extend from a lower region of the straight section of rail 12 in an arcuate manner. First portion 12f′ may be connected to second portion 12f″ by an arcuate section 15a. Although a particular configuration of second end 12f has been illustrated described, it will be understood that second end 12f may be of any suitable configuration.

Each rail 12 may include a slot 24 (FIG. 3A) defined by interior side 12b of rail 12. Slot 24 may extend continuously from first end 12e of rail 12 to second end 12f thereof or may extend for part of the distance between first end 12e to second end 12f. Slot 24 may not be in communication with cavity 18. Although each rail 12 has been described as defining interior cavity 18, each rail 12 may, instead, be fabricated as a substantially solid structure free of interior cavity 18 while still including slot 24 defined by interior side 12b.

Rails 12 are connected together by the plurality of parallel spaced apart rib members 14. Specifically, each rib member 14 extends between the opposed interior surfaces 12b of the two rails 12. Each rib member 14 may be fixedly secured to each rail 12 and the plurality of rib members 14 is spaced at regular intervals from each other along the length of the rails 12.

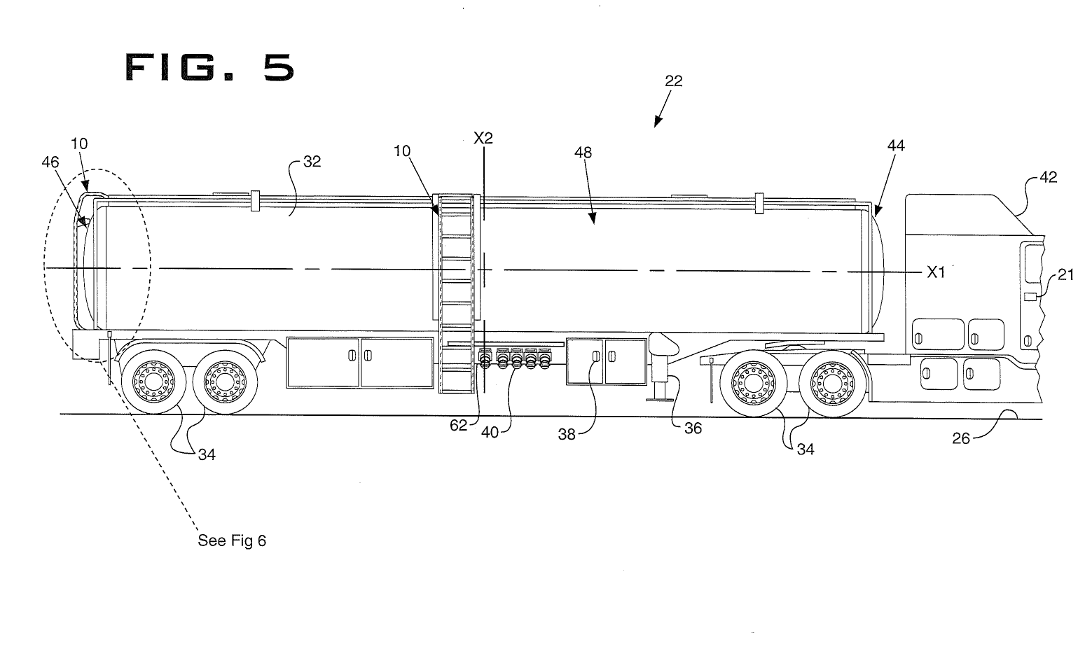

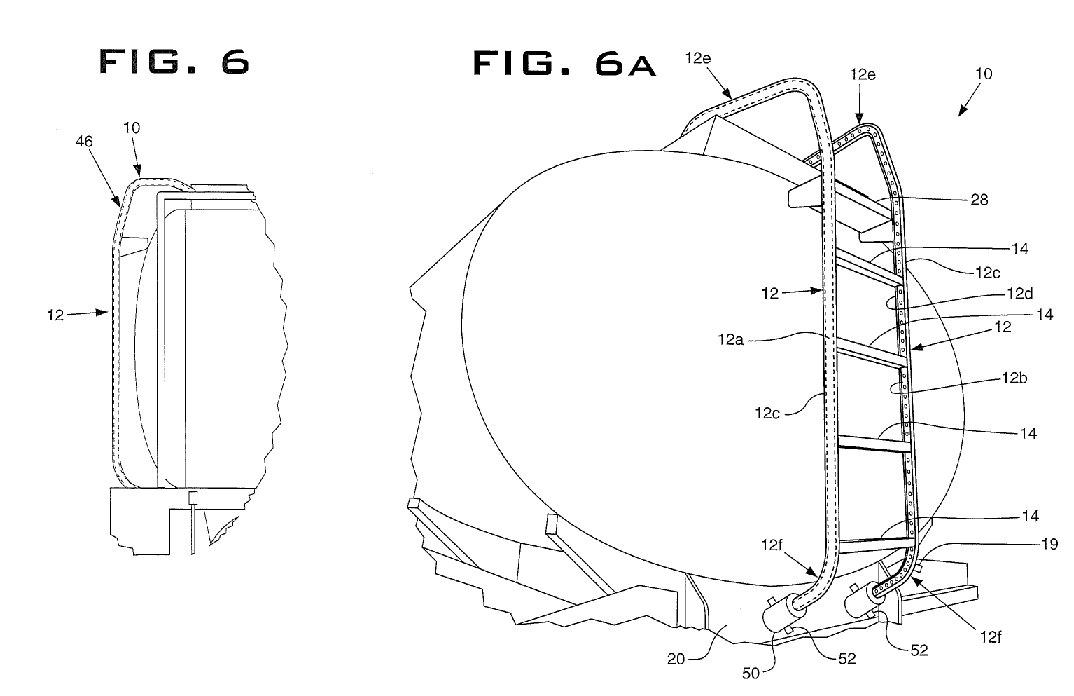

Each rib member 14 may include a first surface 14a and a second surface 14b. First surface 14a of the rib member 14 may be provided with a texture thereon that aids in preventing an operator of ladder 10 from slipping on first surface 14a when climbing up and down the plurality of rib members 14. It will also be noted that the plurality of rib members 14 are configured so that they may be substantially horizontal, or parallel, with respect to a ground surface 26 when ladder 10 is in an operational position as shown in FIG. 5, FIG. 6 and FIG. 6A.

A substantially rectangular platform 28 may be provided on ladder 10 to provide a landing upon which an operator may climb onto or off of ladder 10 with increased safety. Platform 28 may extend between interior surfaces 12b of the rails 12 proximate first ends 12e thereof. Platform 28 may be fixedly secured to each rail 12 a distance above an uppermost one of the plurality of rib members 14. Platform 28 may include a first surface 28a and a second surface 28b. First surface 28a may be provided with a texture to aid in preventing the operator from slipping thereon when climbing up and down ladder 10. It will also be noted that platform 28 may be configured so that it is substantially horizontal, or parallel, with respect to ground surface 26 when ladder 10 is in an operational position as shown in FIG. 5, FIG. 6 and FIG. 6A.

As shown in FIG. 1 and FIG. 3A, light source 16 may be provided in slot 24 defined in interior side 12b of one or both rails 12. Light source 16 may be placed in electrical communication with a power supply 17 that supplies electrical current to light source 16. It is envisioned that power supply 17 may comprise a conventional battery or a solar powered battery. In other instances, ladder 10 may be wired to a source of direct or alternating current. Light source 16 may be any suitable light source, including, but not limited to, a light emitting diode (LED) strip that is secured or adhered into slot 24. Light source 16 may comprise any other suitable source of illumination.

Light source 16 may be activated by the operator contacting a switch 19 (FIG. 1) provided on ladder 10. Alternatively, light source 16 may be turned on and off by a wired control 38 (FIG. 5) or a wireless device 21 (FIG. 5). It is further envisioned that light source 16 may incorporate a photosensitive element 23 (FIG. 1) that may detect changes in ambient light conditions and which may activate light source 16 when the it becomes dark outside and which deactivate light source 16 when it becomes sufficiently light enough that an operator would readily see ladder 10.

As shown in FIG. 1 and FIG. 3A, light source 16 may include a body portion 16a and an illumination portion 16b. Body portion 16a may be configured to be complementary to the shape of slot 24 and therefore be able to be fixedly retained within slot 24 of rail 12. Illumination portion 16b may comprise a plurality of spaced-apart LEDs that will emit light from interior side 12b of rails 12 and generally towards the interior side 12b of the other rail 12. As a result, the LEDs will emit light onto at least a portion of the plurality of rib members 14 extending between the interior sides 12b of the two rails 12.

As shown in FIG. 3B, it is also envisioned that light source 16 may have a different body portion 16a configuration than the body portion 16a configuration shown in FIG. 3A. Further, as shown in FIG. 3B, light source 16 may have two illumination portions 16b. In this embodiment, slot 24 may be configured to be complementary to the shape of the light source 16 and therefore be able to fixedly retain the light source 16 within slot 24 of rail 12. Illumination portions 16b may comprise a plurality of spaced-apart LEDs that will emit light from interior side 12b of rails 12 and generally towards the interior side 12b of the other rail 12 at an angle. As a result, the LEDs will emit light onto at least a portion of the plurality of rib members 14 extending between the interior sides 12b of the two rails 12 while also emitting light towards first edge 12c and second edge 12d from one rail 12 to the other rail 12.

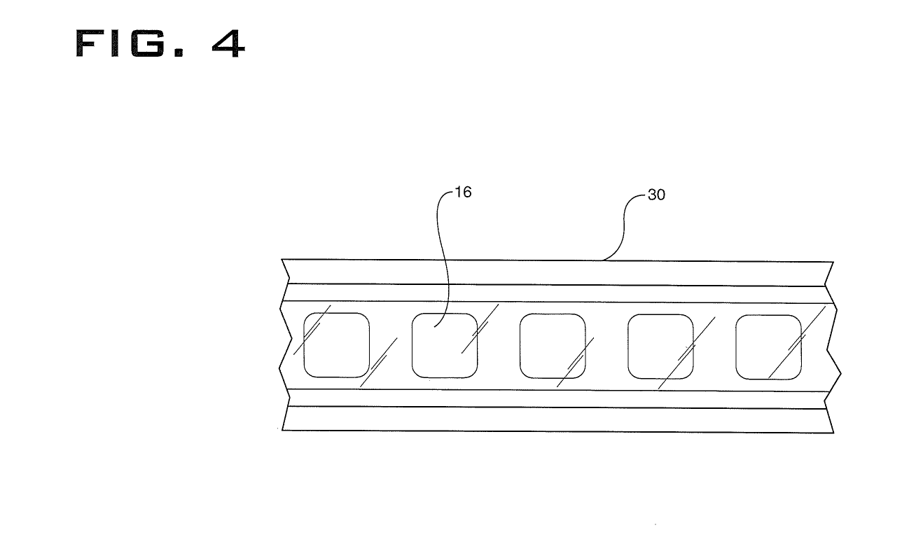

It is also envisioned that light source 16 may, alternatively be operably connected with a strip 30 (FIG. 4) and be glued or otherwise secured to interior sides 12b of rails 12 instead of being secured within slot 24. Although light source 16 has been described as being mounted within slot 24 of rail 12 or secured onto interior side 12b when a slot 24 is not provided, it will be understood that light source 16 may be mounted in any suitable manner to interior side 12b. It will further be understood that a light source 16 may additionally or alternatively be provided on any other surface of rail 12, such as exterior side 12a of rail 12 or first edge 12c or second edge 12d thereof.

As shown in FIG. 2, light source 16 may be additionally or alternatively provided on one or more of the plurality of rib members 14. Specifically, light source 16 may be operably connected with a strip 30 (FIG. 4) that may be applied to second surface 14b of rib members 14 in any suitable manner. Light source 16 may emit light outwardly from second surface 14b of an upper rib member 14 towards a first surface 14a of an adjacent lower rib member 14. Instead of providing light source 16 on strip 30, a slot similar to slot 24 may be formed in either the first surface 14a or second surface 14b of each rib member 14 and light source 16 may be applied into said slot in a similar manner to what is illustrated in FIG. 3A. It will further be understood that light source 16 may additionally or alternatively be provided an a front surface or rear surface that connects first and second surfaces 14a, 14b or may even be placed within an interior of rib members 14 if first surface 14a or second surface 14b are made of a transparent or opaque material.

As shown in FIG. 2, light source 16 may additionally or alternatively be carried by platform 28. Specifically, light source 16 may be operably connected with strip 30 (FIG. 4) and be applied to one or both of the first surface 28a and second surface 28b of platform 28 in any suitable manner. Platform 28 may alternatively be formed with slots similar to slot 24 in one or both of the first surface 28a and second surface 28b and light source 16 may be provided in this slot in a similar manner to what is shown in FIG. 3A. Light source 16 in second surface 28b of platform 28 may emit light toward an uppermost one of the rib members 14. Light source 16 may alternatively or additionally be provided on the front and rear surfaces that connect first surface 28a to second surface 28b.

FIG. 5 shows ladder 10 disposed on a specific support member 20, which is tanker truck 22. Tanker truck 22 may be of a usual construction and comprise an elongated, generally cylindrical tank 32, which is supported by one or more pairs of wheel assemblies 34. Tanker truck 22 may include landing gear 36, and various valves and other controls indicated generally at 38. Tanker truck 22 may include a fuel nozzle 40 adjacent the tank 32. The types of controls 38 and particular shape of tank 32 will be dependent upon the particular load to be transported within a hollow interior of tank 32. A usual tractor or cab 42 provides the pulling force for tanker truck 22. Tank 32 of tanker truck 22 may include a first end 44 and a second end 46 that define a longitudinal axis “X1” therebetween. Tank 32 may include a first side 48 spaced apart from a second side (not shown) and defining a transverse direction therebetween.

As shown in FIG. 5, FIG. 6 and FIG. 6A, a first ladder 10 may be mounted adjacent second end 46 of tank 32 and a second ladder 10 may be mounted adjacent first side 48 of tank 32 in any suitable manner. FIG. 6 and FIG. 6A show an enlarged view of the second ladder 10 mounted adjacent second end 46 of tank 32. The second ladder 10 may be mounted on tanker truck 22 via mounting portions 50 and fasteners 52, such as bolts; however, ladder 10 may be mounted to tanker truck 22 in any suitable manner. Although ladder 10 has been described as being fixedly attached to tanker truck 22, it is envisioned that ladder 10 may be removably attached to tanker truck 22 or any other suitable support member 20.

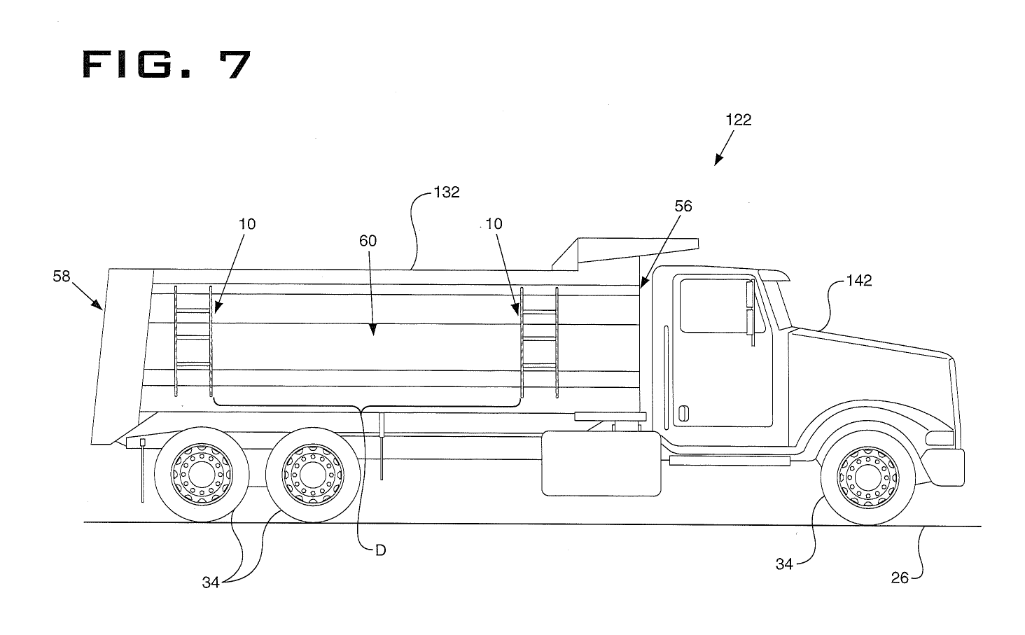

FIG. 7 shows system 10 disposed on a specific support member 20, a conventional dump truck 122. Dump truck 122 may be of a usual construction comprising of an elongated, generally rectangular dump bed 132, which is supported by one or more pairs of wheel assemblies 134. A usual tractor or cab 142 provides the pulling force for dump truck 122. The bed 132 of dump truck 122 may include a first end 56 and a second end 58. Bed 132 may also include a first side 60 spaced apart from a second side (not shown). A pair of ladders 10 may be mounted adjacent first side 60 of bed 132 to enable an operator to climb up to a top of bed 132. Although particular locations of ladders 10 have been described, ladders 10 may be mounted in any suitable location on dump truck 122. Further, it is envisioned that ladder 10 may be adapted to be removable and portable. Still further, it is envisioned that ladder 10 may be adapted to be retractably mounted to dump truck 122.

In operation, and with reference to FIG. 5, FIG. 6 and FIG. 6A, ladder 10 is illustrated as being engaged on tanker truck 22. Specifically, ladder 10 is fixedly secured to tank 32 via mounting portions 50 and fasteners 52. Light source 16 is activated by switch 19 to emit light. The operator is able to climb up and down the plurality of rib members 14 and platform 28 while light source 16 (provided on one or more of rails 12, rib members 14 and platform 28) emits light onto the plurality of rib members 14. The operator is therefore readily able to see rails 12 to grip the same and is readily able to see rib members 14 and platform 28 to step onto or step off of the same.

An exemplary method of the use of ladder 10 may be better appreciated with reference to a flow diagram. While for purposes of simplicity of explanation, the illustrated methodology is shown and described as a series of blocks, it is to be appreciated that the methodologies are not limited by the order of the blocks, as some blocks can occur in different orders and/or concurrently with other blocks from that shown and described. Moreover, less than all the illustrated blocks may be required to implement an example methodology. Blocks may be combined or separated into multiple components. Furthermore, additional and/or alternative methodologies can employ additional, not illustrated blocks.

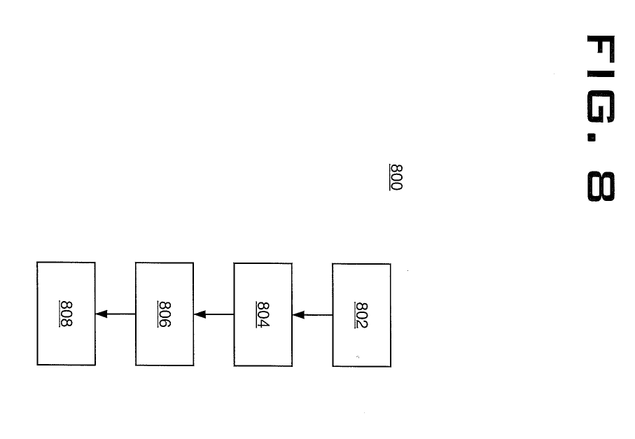

In accordance with one aspect of the present disclosure, FIG. 8 depicts a flowchart of an exemplary method 800 for illuminating a safety ladder 10. Method 800 provides ladder 10 including two rails 12 and the plurality of rib members 14 connected to rails 12, which is shown generally at 802. Method 800 mounts light source 16 to ladder 10, which is shown generally at 804. Method 800 emits light from light source 16, which is shown generally at 806. Method 800 illuminates one of the rails 12 or one of the plurality of rib members 14 with light emitted from light source 16, which is shown generally at 808. Method 800 may provide that the step of mounting light source 16 to ladder 10 comprises defining slot 24 in one of the rails 12 or one of the plurality of rib members 14 or platform 28 and fixedly securing light source 16 within slot 24. Method 800 may provide that the step of mounting light source 16 to ladder 10 comprises providing a plurality of individual light sources 16 on strip 30 and securing strip 30 to one of the rails 12 or one of the plurality of rib members 14 or to platform 28. Method 800 provides a power supply 17 operably connected to light source 16.

While various inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein.

More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

Also, various inventive concepts may be embodied as one or more methods, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.” The phrase “and/or,” as used herein in the specification and in the claims (if at all), should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc. As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures.

An embodiment is an implementation or example of the present disclosure. Reference in the specification to “an embodiment,” “one embodiment,” “some embodiments,” “one particular embodiment,” or “other embodiments,” or the like, means that a particular feature, structure, or characteristic described in connection with the embodiments is included in at least some embodiments, but not necessarily all embodiments, of the invention. The various appearances “an embodiment,” “one embodiment,” “some embodiments,” “one particular embodiment,” or “other embodiments,” or the like, are not necessarily all referring to the same embodiments.

In the foregoing description, certain terms have been used for brevity, clearness, and understanding. No unnecessary limitations are to be implied therefrom beyond the requirement of the prior art because such terms are used for descriptive purposes and are intended to be broadly construed.

Moreover, the description and illustration of the preferred embodiment of the disclosure are an example and the disclosure is not limited to the exact details shown or described.

1. A lighted safety ladder comprising:
two rails;
a plurality of rib members connected to the two rails; and
a light provided on one of the two rails; wherein the light illuminates towards the other rail.

2. The lighted safety ladder of claim 1, further comprising:
a second light provided on the rail; wherein the first light and the second light illuminate towards one another.

3. The lighted safety ladder of claim 1, further comprising:
a second light provided on at least one of the plurality of rib members; wherein the second light illuminates generally vertically downwards.

4. The lighted safety ladder of claim 1, further comprising:
a platform connected to the two rails above the plurality of rib members; and
a second light source provided on the platform; wherein the second light illuminates generally perpendicular to the illumination of the light carried by the rail.

5. The lighted safety ladder of claim 1, further comprising: an interior side of the rail carrying the light defining a slot therein; wherein the interior side is connected to the plurality of rib members; and wherein the light is fixedly retained within the slot.

6. The lighted safety ladder of claim 1, further comprising: a strip; wherein the light is connected to the strip.

7. The lighted safety ladder of claim 6, further comprising: an interior side of the rail carrying the light; wherein the strip is applied to the interior side.

8. The lighted safety ladder of claim 6, further comprising:
a platform extending between the rails; and wherein the strip is applied to the platform.

9-20. (canceled)

21. The lighted safety ladder of claim 5, further comprising:
a body portion of the light complementary in shape to the slot and fixedly retained within the slot; and
an illumination portion of the light operably connected to the body portion.

22. The lighted safety ladder of claim 21, further comprising:
a plurality of spaced-apart light emitting diodes (LEDs) of the illumination portion; wherein the plurality of spaced apart LEDs illuminate towards the other rail.

23. The lighted safety ladder of claim 5, further comprising:
a body portion of the light complementary in shape to the slot and fixedly retained within the slot;
a first illumination portion of the light operably connected to the body portion; wherein the first illumination portion is angled in a first direction that is non-perpendicular to the interior side.

24. The lighted safety ladder of claim 23, further comprising:
a first plurality of spaced-apart light emitting diodes (LEDs) of the first illumination portion; wherein the first plurality of spaced apart LEDs illuminate towards the other rail.

25. The lighted safety ladder of claim 23, further comprising:
a second illumination portion of the light operably connected to the body portion; wherein the second illumination portion is angled in a second direction that is non-perpendicular to the interior side.

26. The lighted safety ladder of claim 25,
a second plurality of spaced-apart LEDs of the second illumination portion; wherein the second plurality of spaced apart LEDs illuminate towards the other rail.

27. The lighted safety ladder of claim 1, further comprising:
a power supply operably connected to the light adapted to provide power to the light; and
a photosensitive element operably connected to the light; wherein the photosensitive element detects changes in ambient light conditions to connect and disconnect the light from the power supply based on the ambient light conditions.

28. The lighted safety ladder of claim 1 provided on a support member.

29. The lighted safety ladder of claim 28, wherein the support member is a vehicle.

30. The lighted safety ladder of claim 29, wherein the vehicle is a truck.

31. The lighted safety ladder of claim 30, further comprising:
a tank of truck including a first end and a second end; wherein the lighted safety ladder is provided adjacent the second end of the tank.

32. The lighted safety ladder of claim 30, further comprising:
a tank of truck including a first side and a second side; wherein the lighted safety ladder is provided adjacent the first side of the tank.

33. The lighted safety ladder of claim 28, wherein the support member is a moveable platform having ground engaging wheels.

34. A lighted safety ladder comprising:
two side rails having at least three rib members connected therebetween and defining a space between adjacent rib members;
a first light illuminating the space defined between a first rib member and a second rib member; and
a second light illuminating the space between the second rib member and the third rib member.

35. The lighted safety ladder of claim 34, wherein the first light and the second light are carried by the rails.

36. The lighted safety ladder of claim 34, wherein the first light is carried by the second rib member and the second light is carried by the third rib member.

37. The lighted safety ladder of claim 34, wherein the first light is carried by one of the rails and the second light is carried by one of the at least three rib members.
